(19) United States
(12) Patent Application Publication
(10) Pub. No.: US 2008/0205713 A1
(43) Pub. Date: Aug. 28, 2008

(54) Image reading device, image reading method, and fingerprint reading device

(75) Inventor: Kenichirou Nagashita, Iizuka-shi (JP)

Correspondence Address: LADAS & PARRY LLP, 26 WEST 61ST STREET, NEW YORK, NY, 10023, US

(73) Assignee: MITSUMI ELECTRIC CO., LTD.

(21) Appl. No.: 11/986,781

(22) Filed: Nov. 26, 2007

(30) Foreign Application Priority Data
Feb. 15, 2007 (JP) 2007-035411

(51) Int. Cl. G06K 9/00; G06K 9/60

(52) U.S. Cl. 382/124; 382/274

(57) ABSTRACT

An image reading device is disclosed. The image reading device includes an image reading unit which reads an image of an object to be read, and an image reading control unit which adjusts a reading period of the image by the image reading unit to one of predetermined values based on intensity of light input to the image reading unit after setting the reading period of the image by the image reading unit to be a minimum value.

### BACKGROUND OF THE INVENTION

1. Field of the Invention

The present invention relates to an image reading device, an image reading method, and a fingerprint reading device which can read an image or a fingerprint image of a person in an environment where ambient light is strong.

2. Description of the Related Art

Recently, in order to maintain security for electronic devices, for example, a computer and a mobile telephone, a biometric technology, for example, a fingerprint authentication technology is used. As a device for realizing the fingerprint authentication for a person, a fingerprint reading device is used. The fingerprint reading device optically or electro-statically reads a fingerprint image of a person by the fingerprint contacting an image reading surface of the fingerprint reading device.

In addition, as the fingerprint reading device, there is a sweep type fingerprint reading device. In the sweep type fingerprint reading device, a finger of a person is swept on a surface of the device, and a fingerprint image of the finger is read line-by-line by an image sensor, the fingerprint images read by the lines of the image sensor are combined, and the fingerprint image of the finger is obtained.

Further, as the fingerprint reading device, there is an optical type fingerprint reading device. In the optical type fingerprint reading device, the refractive index difference of light between concave sections (air layers between the concave sections of the fingerprint and the surface of the finger) and convex sections of the fingerprint is read by an optical device using an optical fiber bundle called an image guide, and a fingerprint image is obtained.

In a case where infrared light emitted from a built-in LED (light emitting diode) is used as the light, when solar light is strongly irradiated on a line image sensor in addition to irradiating the infrared light reflected from the fingerprint on the line image sensor, the light amount received by the line image sensor may exceed a predetermined amount, and the line image sensor may be saturated or may malfunction. Specifically, an analog signal output from the line image sensor is generally output corresponding to the intensity of light irradiated onto the line image sensor; however, when the solar light is strongly irradiated on the line image sensor, the analog signal output from the line image sensor reaches a limit value or becomes an unintentional value.

In the fingerprint reading device, a signal is output corresponding to the concave-convex surface of the fingerprint; however, when the line image sensor is saturated, the signal becomes flat and the image of the fingerprint cannot be obtained, or a clear image of the fingerprint cannot be obtained. Consequently, fingerprint authentication cannot be executed. In order to avoid the above problem, the sensitivity of the fingerprint device must be adjusted.

In Patent Document 1, a two-dimensional photo sensor system is disclosed. In the two-dimensional photo sensor system, specific values are measured by changing the sensitivity, and optimum sensitivity is determined by the measured values.

In Patent Document 2, an image processing device is disclosed. In the image processing device, when the amount of exposure is excessive, the storing period of light is adjusted so that the amount of exposure becomes small, and when the amount of exposure is small, the intensity of light from a light source is adjusted so that the amount of exposure becomes large.

[Patent Document 1] Japanese Patent No. 3116950

[Patent Document 2] Japanese Laid-Open Patent Application No. 2003-32453

### SUMMARY OF THE INVENTION

The present invention may provide an image reading device, an image reading method, and a fingerprint reading device which can surely obtain an image of an object or a fingerprint image of a person in an environment where ambient light is strong.

According to one aspect of the present invention, there is provided an image reading device. The image reading device includes an image reading unit which reads an image of an object to be read, and an image reading control unit which adjusts a reading period of the image by the image reading unit to one of predetermined values based on intensity of light input to the image reading unit after setting the reading period of the image by the image reading unit to be a minimum value.

According to another aspect of the present invention, when the intensity of the light input to the image reading unit does not reach a predetermined value, the reading period of the image by the image reading unit is extended.

According to another aspect of the present invention, the reading period of the image by the image reading unit is extended step by step by a predetermined period.

According to another aspect of the present invention, the image reading control unit makes the image reading unit transfer the image read during the reading period to the image reading control unit during a transferring period which is set after the reading period, and the transferring period is constant.

According to another aspect of the present invention, there is provided an image reading method in an image reading device having an image reading unit which reads an image of an object to be read. The image reading method includes the step of adjusting a reading period of the image in the image reading unit to one of predetermined values based on intensity of light input to the image reading unit after setting the reading period of the image by the image reading unit to be a minimum value.

According to another aspect of the present invention, there is provided a fingerprint reading device. The fingerprint reading device includes an image reading unit which reads a fingerprint image of a person, and an image reading control unit which adjusts a reading period of the image by the image reading unit to one of predetermined values based on intensity of light input to the image reading unit after setting the reading period of the image by the image reading unit to be a minimum value.

According to an embodiment of the present invention, intensity of light input to an image reading unit is detected, and when the detected intensity is less than a predetermined value, a reading period of an image by the image reading unit is increased step by step. Therefore, even in an environment where the intensity of ambient light is high, the image can be immediately detected. In addition, the reading period of the image by the image reading unit is adjusted corresponding to the intensity of the ambient light and the sensitivity of the image reading device is adjusted by the adjusted reading period. Consequently, image signals of the image can be obtained at a suitable level. With this, the image can be surely obtained.

Features and advantages of the present invention will become apparent from the following detailed description when read in conjunction with the accompanying drawings.

### BRIEF DESCRIPTION OF THE DRAWINGS

FIG. 1 is a block diagram showing an image reading device according to an embodiment of the present invention;

FIG. 2 is a perspective view of the image reading device shown in FIG. 1;

FIG. 3 is a flowchart showing fingerprint image reading operations by a processing unit shown in FIG. 1;

FIG. 4 is a flowchart showing processes in finger detecting operations shown in FIG. 3;

FIG. 5 is a flowchart showing processes in sensitivity adjusting operations shown in FIG. 3;

FIG. 6 is a flowchart showing processes in image obtaining operations shown in FIG. 3; and

FIG. 7 is a timing chart of image signals according to the embodiment of the present invention.

### DETAILED DESCRIPTION OF THE PREFERRED EMBODIMENT

Referring now to the drawings, an embodiment of the present invention is described.

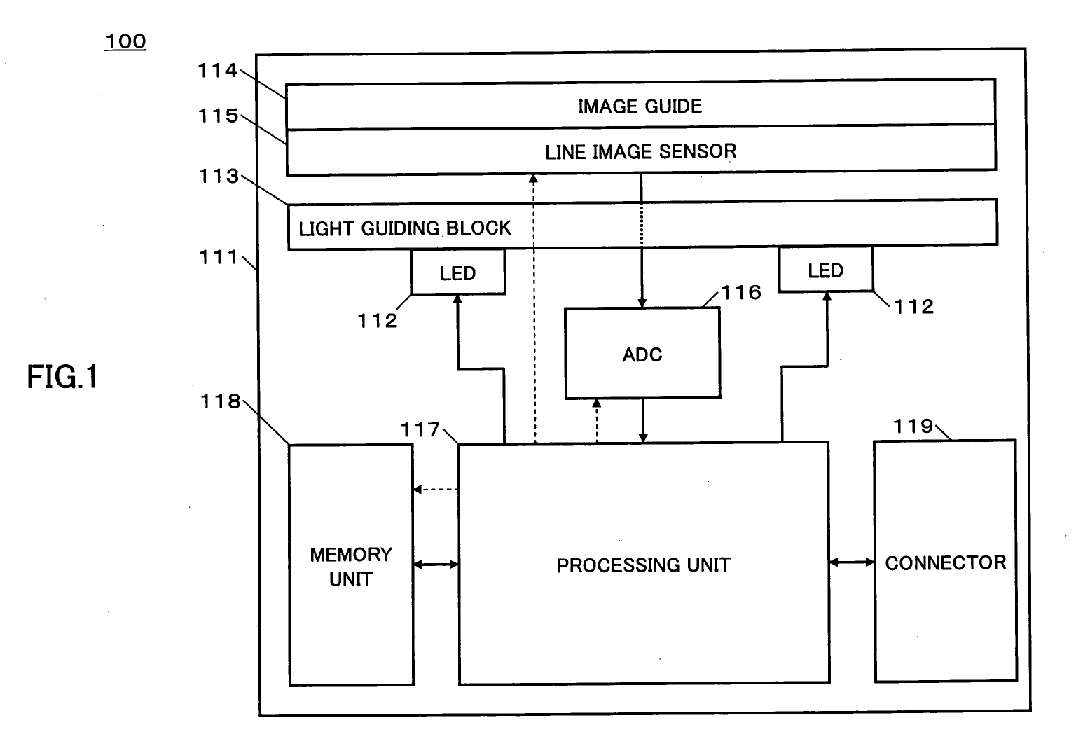

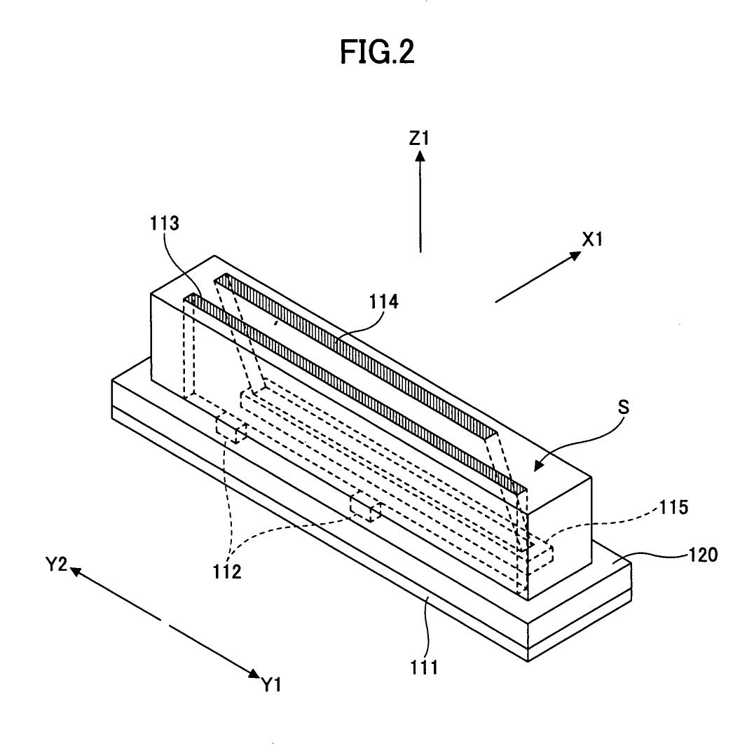

FIG. 1 is a block diagram showing an image reading device according to the embodiment of the present invention. FIG. 2 is a perspective view of the image reading device shown in FIG. 1.

In the embodiment of the present invention, as the image reading device, a sweep type fingerprint reading device 100 is used. However, the image reading apparatus is not limited to the sweep type fingerprint reading device 100, and the embodiment of the present invention can be applied to any image reading device.

The sweep type fingerprint reading device 100 includes an image reading unit which reads an image of an object and an image reading control unit which processes the image read by the image reading section.

As shown in FIGS. 1 and 2, the sweep type fingerprint reading device 100 includes a PCB (printed circuit board) 111. LEDs 112, a light guiding block 113, an image guide 114, a line image sensor 115, an ADC (analog to digital converter) 116, a processing unit 117, a memory unit 118, and a connector 119 are mounted on the PCB 111. In addition, the structure in which the above elements are mounted on the PCB 111 is covered with resin 120 by molding.

The image reading unit is mainly formed of the line image sensor 115, and the image reading control unit is mainly formed of the processing unit 117.

The LEDs 112 emit light by being driven by a driving signal from the processing unit 117. The light emitted from the LEDs 112 is input to the light guiding block 113. The light guiding block 113 is formed of, for example, transparent resin or half-transparent resin. The light guiding block 113 guides the light emitted from the LEDs 112 to an image reading surface “S” and the guided light is output in the arrow direction Z1 from the image reading surface “S”.

A finger of a person to be read contacts the image reading surface “S” and is swept, for example, in the arrow direction X1. The light output from the light guiding block 113 is reflected on a surface of the finger and the reflected light is input to the image guide 114. The image guide 114 is formed by the following method. First, for example, optical fibers are bundled and the bundled optical fibers are adhered so that both end surfaces of the bundled optical fibers are parallel, and the adhered optical fibers are cut by having a predetermined angle for the extending direction of the optical fibers. The image guide 114 is disposed so that the long length direction of the image guide 114 is the arrow directions Y1 and Y2. The light reflected from the convex sections of the fingerprint of the finger at one end surface of the image guide 114 is guided to the other end surface of the image guide 114, and the light reflected from the concave sections of the fingerprint of the finger at the one end surface of the image guide 114 does not reach the other end surface of the image guide 114 by being irregularly reflected at the concave sections of the fingerprint. With this, bright parts and dark parts are generated on the other end surface of the image guide 114 corresponding to the fingerprint. The line image sensor 115 is disposed on the other end surface of the image guide 114.

The line image sensor 115 converts an optical image appearing on the other end surface of the image guide 114 into electric signals. In the line image sensor 115, photodiodes or phototransistors are arrayed in the arrow directions Y1 and Y2 on one line or plural lines, and each line converts the optical image into the electric signals (image signals). At this time, periods, for example, an image reading period in the line image sensor 115, that is, an electric charge storing period in the line image sensor 115, and an image transferring period from the line image sensor 115 to the processing unit 117, are controlled by timing control signals output from the processing unit 117.

The image signals read by the line image sensor 115 are input to the ADC 116. The ADC 116 converts the image signal of each pixel into digital data. The digital data output from the ADC 116 are input to the processing unit 117.

The processing unit 117 is formed of, for example, an ASIC (application specific integrated circuit) or a microcomputer; at the time of fingerprint reading operations, the processing unit 117 generates a fingerprint image from the digital data output from the ADC 116. The sweep type fingerprint reading device 100 can be used as a pointer generator for a computer (not shown) when the sweep type fingerprint reading device 100 is connected to the computer. At the time of pointing operations, the processing unit 117 generates data which move a pointer based on movement of the fingerprint image. That is, the pointer is moved corresponding to the movement of the finger.

In more detail, at the time of the fingerprint reading operations, the fingerprint sweeping on the image reading surface “S” is read by the line image sensor 115 line by line, the read image signals are converted by the ADC 116, and the processing unit 117 generates the fingerprint image from the digital data output from the ADC 116. In addition, at the time of the pointing operations, the processing unit 117 detects the moving amount and moving direction of the read fingerprint image, generates the data for moving a pointer, and transmits the generated data to the (host) computer via the connector 119. In addition, the processing unit 117 detects the intensity of ambient light input to the line image sensor 115 based on the electric signals converted by the ADC 116 and controls the reading period, that is, the electric charge storing period of the line image sensor 115 based on the detected intensity of the ambient light.

In addition, the processing unit 117 controls the light emitting timing of the LEDs 112. For example, when the moving speed of the finger is slower than a predetermined speed, the processing unit 117 controls the line image sensor 115 so that the interval between the reading periods by the line image sensor 115 becomes greater than a predetermined interval. In addition, when the moving speed of the finger is slower than a predetermined speed, the processing unit 117 controls the processing unit 117 itself, the LEDs 112, and the line image sensor 115 to intermittently operate. The memory unit 118 is formed of, for example, an SRAM (static random access memory), and works as an operating memory area of the processing unit 117.

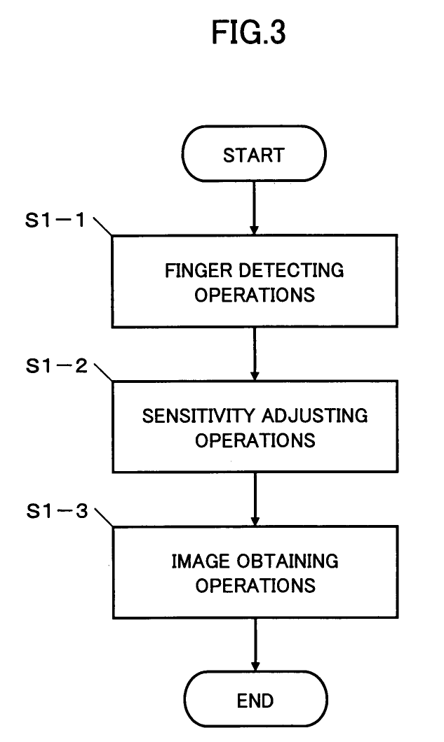

Next, referring to FIG. 3, fingerprint image reading operations by the processing unit 117 are described.

FIG. 3 is a flowchart showing the fingerprint image reading operations by the processing unit 117.

As shown in FIG. 3, the fingerprint image reading operations include finger detecting operations (S1-1), sensitivity adjusting operations (S1-2), and image obtaining operations (S1-3).

In the finger detecting operations (S1-1), the processing unit 117 determines whether a finger to be read is on the image reading surface “S” of the sweep type fingerprint reading device 100. In the sensitivity adjusting operations (S1-2), the processing unit 117 suitably adjusts sensitivity for obtaining a clear fingerprint image of the finger by adjusting the reading period (storing period) of the fingerprint image in the line image sensor 115. In the image obtaining operations (S1-3), the processing unit 117 obtains the fingerprint image.

Next, referring to the drawings, processes in corresponding operations S1-1, S1-2, and S1-3 are described in detail.

First, the processes in S1-1 (the finger detecting operations) are described in detail.

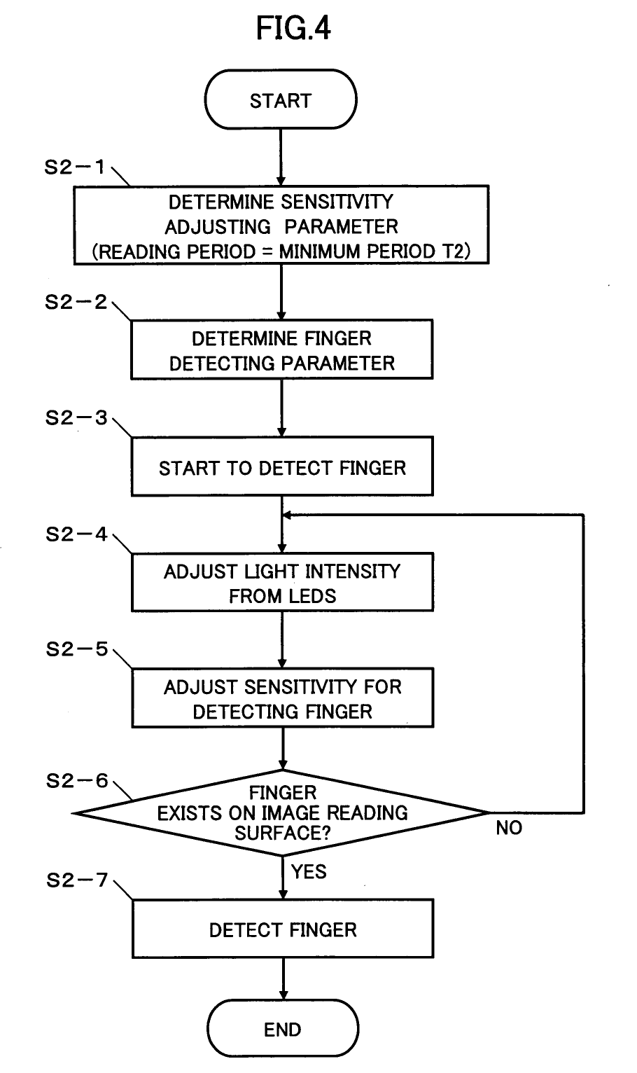

FIG. 4 is a flowchart showing processes in the finger detecting operations shown in S1-1 of FIG. 3. That is, in the processes, it is determined whether a finger is on the image reading surface “S”.

First, the processing unit 117 determines a sensitivity adjusting parameter (S2-1). The sensitivity adjusting parameter is, for example, the reading period (storing period) of a finger image in the line image sensor 115, and is a value which is registered beforehand.

In the present embodiment, as the sensitivity adjusting parameter, the minimum period “T2” is determined as the reading period of the finger image. The minimum period “T2” is the minimum reading period during which the line image sensor 115 can read an image. When the reading period is determined to be the minimum period “T2”, a finger image can be surely detected even if the solar light is strongly irradiated on the image reading surface “S” of the sweep type fingerprint reading device 100.

Next, the processing unit 117 determines a finger detecting parameter (S2-2). The finger detecting parameter is, for example, an amplification factor of an amplifying circuit (not shown) which amplifies an image signal output from the line image sensor 115, and is a value which is registered beforehand.

The processing unit 117 starts to detect a finger (S2-3). Then the processing unit 117 adjusts light intensity from the LEDs 112 to be constant (S2-4).

The processing unit 117 adjusts sensitivity for detecting the finger (S2-5). In the adjustment of the sensitivity, for example, a maximum signal value Vmax is extracted from pixel signal values output from plural pixels of which one line of the line image sensor 115 is formed. When the maximum signal value Vmax does not reach a predetermined value, the processing unit 117 adjusts the sensitivity by extending the reading period of an image by the line image sensor 115. In this case, since the minimum period “T2” has been determined in S2-1, the reading period is changed to be a longer period (described below) than the minimum period “T2”.

Actually, when a finger does not exist on the image reading surface “S”, the maximum signal value Vmax is small and does not reach a predetermined value; therefore, the reading period is changed depending on necessity.

The processing unit 117 determines whether a finger exists on the image reading surface “S” of the sweep type fingerprint reading device 100 (S2-6). In S2-6, for example, when the maximum signal value Vmax in the pixel signal values output from the plural pixels of which one line of the line image sensor 115 is formed is equal to or more than a predetermined value, the processing unit 117 determines that a finger exists on the image reading surface “S”; when the maximum signal value Vmax is less than the predetermined value, the processing unit 117 determines that a finger does not exist on the image reading surface “S”. In the present embodiment, the maximum signal value Vmax is used for determining whether the finger exists on the image reading surface “S”. However, instead of using the maximum signal value Vmax, an average value of the pixel signal values, or an average value of pixel signal values in which the maximum value and the minimum value are removed can be used.

When it is determined that the finger exists on the image reading surface “S” (YES in S2-6), the processing unit 117 detects the finger (S2-7), and the finger detecting operations end. When it is determined that the finger does not exist on the image reading surface “S” (NO in S2-6), the process returns to S2-4.

In order to realize the finger detecting operations with low power consumption, the processing unit 117 executes the finger detecting operations with an interval of some tens of milliseconds, and the lEDs 112 are intermittently driven.

Light is emitted from the LEDs 112 for approximately 100 μs with the interval of some tens of milliseconds. Consequently, the LEDs 112 are turned off for almost the entire period. When the LEDs 112 are turned off, the sensitivity adjusting operations shown in S1-2 of FIG. 3 are executed.

Next, the processes in the sensitivity adjusting operations shown in S1-2 of FIG. 3 are described in detail. As described above, the sensitivity adjusting operations are executed to obtain a clear fingerprint image.

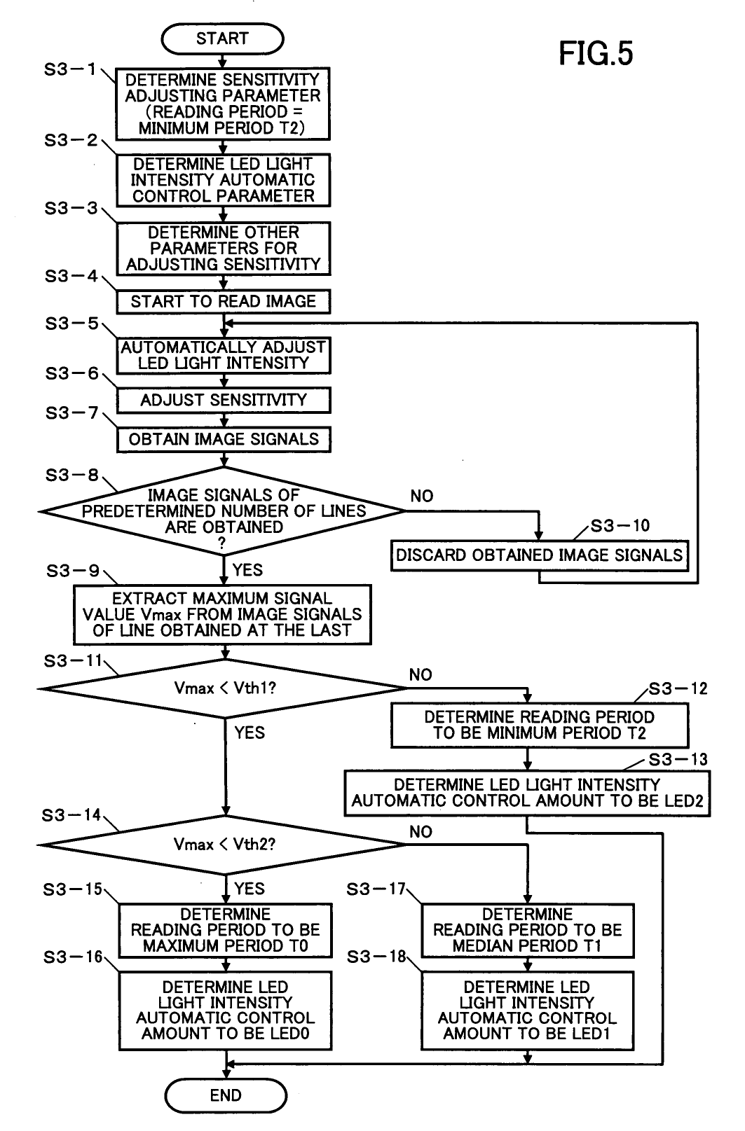

FIG. 5 is a flowchart showing processes in the sensitivity adjusting operations shown in S1-2 of FIG. 3.

First, the processing unit 117 determines a sensitivity adjusting parameter (S3-1). The sensitivity adjusting parameter is, for example, the reading period (storing period) of a fingerprint image by the line image sensor 115 and is a value which is registered beforehand. In the present embodiment, as the sensitivity adjusting parameter, the minimum value “T2” of the reading period is determined. However, a median period “T1” (>T2) can be used as the sensitivity adjusting parameter. When the sensitivity is high and strong solar light is irradiated on the image reading surface “S” of the sweep type fingerprint reading device 100, the line image sensor 115 reaches saturation or may malfunction. Therefore, the reading period of the fingerprint image in the line image sensor 115 is determined to be the minimum period “T2”.

Then the processing unit 117 determines an LED light intensity automatic control parameter for automatically controlling the light intensity of the LEDs 112 (S3-2), and determines other parameters for adjusting the sensitivity (S3-3). The LED light intensity automatic control parameter is, for example, a gain of a closed loop (not shown) for controlling each of the LEDs 112. The other parameters are, for example, an amplification factor of fingerprint image signals read by the line image sensor 115 and a transferring period of the fingerprint image signals from the line image sensor 115 to the processing unit 117.

Next, the processing unit 117 makes the line image sensor 115 start to read image signals by supplying a timing signal to the line image sensor 115 (S3-4).

The processing unit 117 automatically adjusts the LED light intensity based on the image signals read by the line image sensor 115 (S3-5).

In the LED light intensity automatic control, for example, the light intensity of the LEDs 112 is automatically controlled so that an average value of the image signals in a line read by the line image sensor 115 becomes a predetermined value.

The processing unit 117 adjusts the sensitivity (S3-6). The sensitivity is adjusted by the reading period of the image signals by the line image sensor 115 so that an average value of the read image signals of a line becomes a predetermined value. Then the processing unit 117 obtains image signals from the line image sensor 115 by the automatically adjusted LED light intensity and the adjusted sensitivity (S3-7).

The processing unit 117 determines whether image signals of a predetermined number of lines are obtained from the line image sensor 115 (S3-8).

When the processing unit 117 does not obtain the image signals of the predetermined number of lines (NO in S3-8), the processing unit 117 discards the obtained image signals (S3-10). Then the process returns to S3-5.

When the processing unit 117 obtains the image signals of the predetermined number of lines (YES in S3-8), the processing unit 117 extracts a maximum signal value Vmax from the image signals of a line obtained at the last (S3-9).

The processing unit 117 determines whether the obtained maximum signal value Vmax is less than a threshold value Vth1 (S3-11). When the obtained maximum signal value Vmax is equal to or greater than a threshold value Vth1 (NO in S3-11), the processing unit 117 determines that the reading period of the image signals in the line image sensor 115 is the minimum period “T2” (<T1<T0) (S3-12) and the LED light intensity automatic control amount is a minimum controlling amount LED2 (<LED1<LED0) (S3-13).

When the obtained maximum signal value Vmax is less than the threshold value Vth1 (YES in S3-11), the processing unit 117 determines whether the obtained maximum signal value Vmax is less than a threshold value Vth2 (<Vth1) (S3-14). When the obtained maximum signal value Vmax is equal to or more than the threshold value Vth2 (NO in S3-14), the processing unit 117 determines that the reading period of the image signal in the line image sensor 115 is the median period “T1” (>T2) (S3-17) and the LED light intensity automatic control amount is a median controlling amount LED1 (>LED2) (S3-18).

When the obtained maximum signal value Vmax is less than the threshold value Vth2 (<Vth1) (YES in S3-14), the processing unit 117 determines that the reading period of the image signal in the line image sensor 115 is the maximum period “T0” (>T1>T2) (S3-15) and the LED light intensity automatic control amount is a maximum controlling amount LED0 (>LED1>LED2) (S3-16).

As described above, when the maximum signal value Vmax extracted from the image signals output from the line image sensor 115 is equal to or more than the threshold value Vth1, the reading period (storing period) of the image signals in the line image sensor 115 is determined to be the minimum period “T2”. In addition, when the maximum signal value Vmax extracted from the image signals output from the line image sensor 115 exists between the threshold values Vth1 and Vth2, the reading period (storing period) of the image signals in the line image sensor 115 is determined to be the median period “T1”. Further, when the maximum signal value Vmax extracted from the image signals output from the line image sensor 115 is less than threshold values Vth2, the reading period (storing period) of the image signals in the line image sensor 115 is determined to be the maximum period “T0”.

In addition, when the maximum signal value Vmax extracted from the image signals output from the line image sensor 115 is equal to or more than the threshold value Vth1, the LED light intensity automatic control amount is determined to be LED2 (<LED1<LED0). Moreover, when the maximum signal value Vmax extracted from the image signals output from the line image sensor 115 exists between the threshold values Vth1 and Vth2, the LED light intensity automatic control amount is determined to be LED1 (<LED0). Further, when the maximum signal value Vmax extracted from the image signals output from the line image sensor 115 is less than threshold values Vth2, the LED light intensity automatic control amount is determined to be LED0 (>LED1>LED0).

As described above, when the amount of the ambient light is small, the reading period of the image signals by the line image sensor 115 becomes long, and the sensitivity becomes high. With this, the line image sensor 115 can read the image signals (fingerprint image) by optimum sensitivity.

A period for transferring the image signals read by the line image sensor 115 to the processing unit 117 is constant. That is, in the present embodiment, the reading period of the image signals by the line image sensor 115 is variable and the transferring period of the read image signals to the processing unit 117 is constant.

In the present embodiment, the maximum signal value Vmax of the image signal values of the plural pixels of which one line of the line image sensor 115 is formed is used for adjusting the sensitivity of the sweep type fingerprint reading device 100. However, instead of using the maximum signal value Vmax, an average value of the image signal values, or an average value of image signal values in which the maximum value and the minimum value are removed can be used.

As described above, the light intensity of the LEDs 112 is automatically controlled corresponding to the maximum signal value Vmax. However, when the adjusted light intensity of the LEDs 112 is not sufficient, the light intensity of the LEDs 112 in the intermittent operations can be readjusted.

Next, the processes in the image obtaining operations shown in S1-3 of FIG. 3 are described in detail.

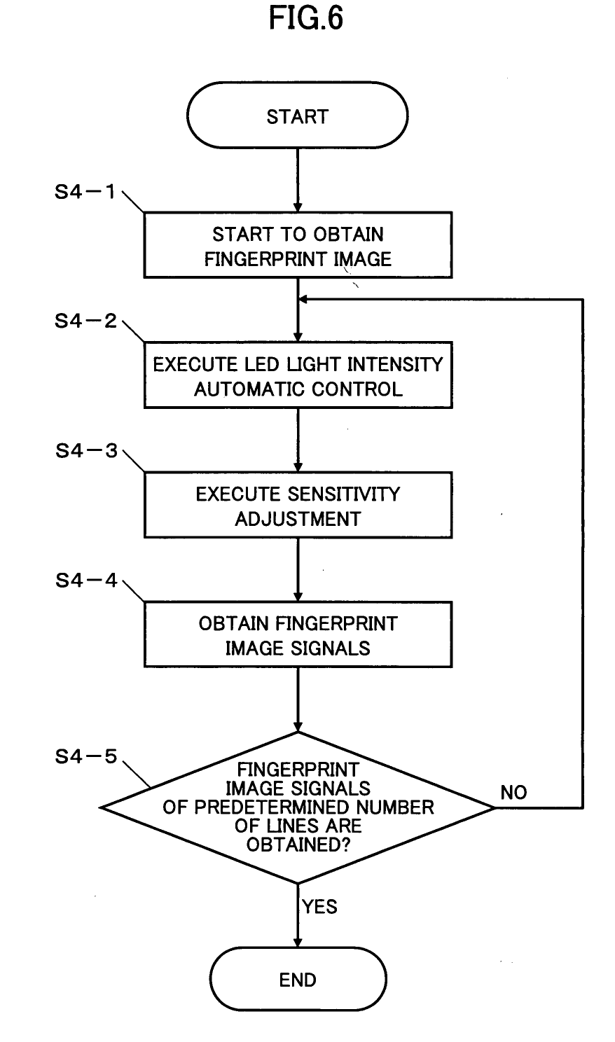

FIG. 6 is a flowchart showing processes in the image obtaining operations shown in S1-3 of FIG. 3.

First, the processing unit 117 starts to obtain a fingerprint image of a person (S4-1). Then the processing unit 117 executes LED light intensity automatic control so that the light intensity of the LEDs 112 becomes the amount controlled in S1-2 (S4-2).

Next, the processing unit 117 executes sensitivity adjustment so that the sensitivity becomes the adjusted sensitivity in S1-2 (S4-3). Then the processing unit 117 obtains fingerprint image signals (S4-4). The processing unit 117 determines whether the fingerprint image signals of a predetermined number of lines are obtained (S4-5). When fingerprint image signals of a predetermined number of lines are not obtained (NO in S4-5), the process returns to S4-2. When fingerprint image signals of a predetermined number of lines are obtained (YES in S4-5), the process ends. That is, the processing unit 117 continues the processes from S4-2 to S4-4 until fingerprint image signals of a predetermined number of lines are obtained.

As described above, even if ambient light, for example, solar light is strong, and the light intensity control of the LEDs 112 does not sufficiently operate, the sensitivity of the sweep type fingerprint reading device 100 can be suitably adjusted by controlling the reading period of image signals by the line image sensor 115.

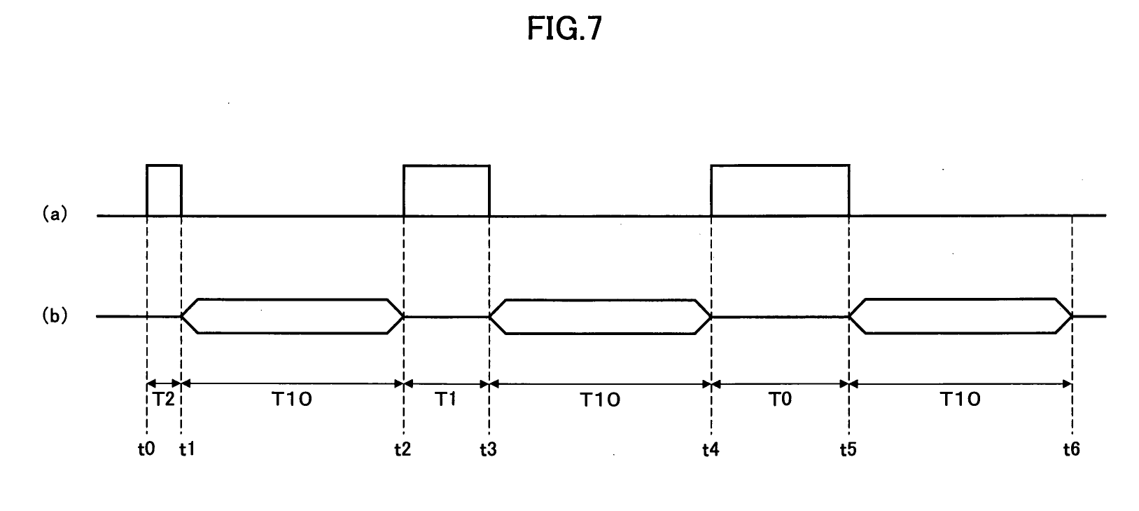

Next, referring to FIG. 7, reading timing of image signals by the line image sensor 115 and transferring timing of the image signals read by the line image sensor 115 to the processing unit 117 are described.

FIG. 7 is a timing chart of image signals according to the embodiment of the present invention. In FIG. 7(a), the reading timing of the image signals by the line image sensor 115 is shown, and in FIG. 7(b), the transferring timing of the image signals read by the line image sensor 115 to the processing unit 117 is shown.

When a sensitivity adjustment process is started at time “t0”, the reading period of image signals by the line image sensor 115 is set to be the minimum period “T2” and the image signals are read by the line image sensor 115. In this case, the maximum signal value Vmax is less than the threshold values Vth1 and Vth2.

The image signals read in the reading period “T2” are transferred to the processing unit 117 during a period “T10” from time “t1” to “t2”. The transferring period “T10” is set to be sufficiently long and the read image signals are transferred to the processing unit 117 before time “t2”. The processing unit 117 extracts the maximum signal value Vmax of the image signals transferred from the line image sensor 115. Since the maximum signal value Vmax is less than the threshold value Vth1, first, the processing unit 117 sets the reading period of the image signals by the line image sensor 115 to be the median period “T1”.

When the transferring period “T10” has passed at time “t2”, the line image sensor 115 sets the reading period of the image signals to be the median period “T1” (>T2) from time “t2” to time “t3”. The line image sensor 115 reads image signals during the median period “T1”. When the line image sensor 115 finishes reading the image signals at time “t3”, the line image sensor 115 transfers the read image signals to the processing unit 117 during the transferring period “T10” from time “t3” to time “t4”.

The processing unit 117 extracts the maximum signal value Vmax of the image signals transferred from the line image sensor 115. Since the maximum signal value Vmax is further less than the threshold value Vth2, the processing unit 117 sets the reading period of the image signals by the line image sensor 115 to be the maximum period “T0” (>T1).

The line image sensor 115 reads image signals during the maximum period “T0” from time “t4” to time “t5” and transfers the read image signals to the processing unit 117 during the transferring period “T10” from time “t5” to time “t6”.

The following are not shown in FIG. 7; however, when the maximum signal value Vmax extracted from the image signals output from the line image sensor 115 is a value between the threshold values Vth1 and Vth2, the reading period of the image signals by the line image sensor 115 is set to be the median period “T1”. When the maximum signal value Vmax extracted from the image signals output from the line image sensor 115 is equal to or more than the threshold value Vth1, the reading period of the image signals by the line image sensor 115 is set to be the minimum period “T2”.

By the above processes, the sensitivity of the sweep type fingerprint reading device 100 is adjusted by controlling the reading period of the image signals by the line image sensor 115. After adjusting the sensitivity by controlling the reading period of the image signals by the line image sensor 115, the image obtaining operations shown in S1-3 of FIG. 3 are executed.

As described above, according to the embodiment of the present invention, since the reading period of the image signals by the line image sensor 115, that is, the storing period of electric charges in the line image sensor 115, is adjusted in real time, suitable sensitivity can be obtained. Therefore, even if the sweep type fingerprint reading device 100 is used in an environment where ambient light is strong, a clear fingerprint image can be obtained without malfunction. Especially, when the sweep type fingerprint reading device 100 is installed in a mobile telephone, since the mobile telephone is often used outdoors, the fingerprint reading function can be sufficiently utilized even if the mobile telephone is used in an environment where solar light is strong.

In addition, since even in the image obtaining operations and the pointing operations, the finger detecting operations can be executed, and the sensitivity adjusting operations can be executed during OFF periods of the LEDs 112. With this, during the image obtaining operations and the pointing operations, the sensitivity adjusting operations can be executed corresponding to a change of environment.

Further, the present invention is not limited to the embodiment, but variations and modifications may be made without departing from the scope of the present invention.

The present application is based on Japanese Priority Application No. 2007-035411 filed on Feb. 15, 2007, with the Japanese Patent Office, the entire contents of which are hereby incorporated herein by reference.

What is claimed is:

1. An image reading device, comprising:
an image reading unit which reads an image of an object to be read; and
an image reading control unit which adjusts a reading period of the image by the image reading unit to one of predetermined values based on intensity of light input to the image reading unit after setting the reading period of the image by the image reading unit to be a minimum value.

2. The image reading device as claimed in claim 1, wherein:
the image reading control unit adjusts the reading period of the image by the image reading unit from the minimum value to one of the predetermined values step by step so as to increase the reading period until the reading period becomes a suitable value based on the intensity of light input to the image reading unit.

3. The image reading device as claimed in claim 1, wherein:
the image reading control unit makes the image reading unit transfer the image read during the reading period to the image reading control unit during a transferring period which is set after the reading period, and the transferring period is constant.

4. An image reading method in an image reading device having an image reading unit which reads an image of an object to be read, comprising the step of:
adjusting a reading period of the image by the image reading unit to one of predetermined values based on intensity of light input to the image reading unit after setting the reading period of the image by the image reading unit to be a minimum value.

5. A fingerprint reading device, comprising:
an image reading unit which reads a fingerprint image of a person; and
an image reading control unit which adjusts a reading period of the image by the image reading unit to one of predetermined values based on intensity of light input to the image reading unit after setting the reading period of the image by the image reading unit to be a minimum value.
